(19) United States
(12) Patent Application Publication
(10) Pub. No.: US 2003/0119644 A1
(43) Pub. Date: Jun. 26, 2003

(54) Method for the preparation of wrapping material used in the manufacture of packs for tobacco products

(76) Inventors: Fiorenzo Draghetti, Medicina (IT); Roberto Polloni, Modigliana (IT); Imelde Bertinelli, Bologna (IT)

Correspondence Address: The Law Offices of Timothy J Klima, Suite 330, One Massachusetts Avenue NW, Washington, DC, 20001, US

(21) Appl. No.: 10/182,984

(22) PCT Filed: Feb. 12, 2001
(86) PCT No.: PCT/IB01/00173

(30) Foreign Application Priority Data
Feb. 16, 2000 (IT) B02000A000069

(51) Int. Cl. B31B 1/00

(52) U.S. Cl. 493/480

(57) ABSTRACT

In a method of preparing the wrapping materials used to fashion packs (20) for tobacco products, typically cigarette packets and cartons, without installing extra machine units on the packer, a sliver (28) or continuous stripe (44) of pre-encoded or recordable magnetic ribbon (25) is applied to selected areas (29) of the wrapping material (21; 35), whereupon the material is divided into smaller strips (31) or sheets (37); these are then coiled into rolls (33) or ordered into stacks (42) of sheets (46) or blanks (41), serving as temporary storage units (34) that can be loaded onto the packer as and when needed. Each pack (20) will consist in at least one specific and essential packaging component (4, 8, 12, 13, 16, 19) obtained from the temporary storage unit (34) and bearing at least one sliver (28) or stripe (44) of the magnetic ribbon (25).

### TECHNICAL FIELD

The present invention relates to a method for the preparation of wrapping material to be used in the manufacture of packs for tobacco products.

In particular, the present invention relates to a method for the preparation of wrapping material for the manufacture of packs containing tobacco products such as cigarettes, cigars or the like, to which reference will be made throughout the following specification albeit with no limitation in scope implied; the invention relates also to a material for manufacturing packets either of the soft type or the rigid type, or for packaging groups of packets either in rigid cartons or in soft overwrappings.

### BACKGROUND ART

Generally speaking, cigarette packets of the soft type present a substantially parallelepiped shape and consist preferably of an inner wrapper fashioned as a rule in paper or metal foil, fully enveloping a group of cigarettes, also an outer wrapper or label folded from a sheet of wrapping material, usually paper, by which the inner wrapper is enveloped in part and the top end face left exposed.

Certain cigarette packets of the soft type can also be fashioned with a single wrapper constituting both the label and the top end face.

Cigarette packets of the rigid type with a hinged lid appear likewise substantially parallelepiped in shape and consist essentially in an outer wrapper of box-like embodiment fashioned from a precreased flat diecut blank, generally card or paperboard, with an inner wrapper normally of paper or metal foil accommodated internally of the outer wrapper, fully enveloping the group of cigarettes and identical in terms of shape to the inner wrapper of the soft type of packet.

The box-like outer wrapping typically comprises a container and a lid hingedly associated with a rear edge of the container, also a reinforcing frame disposed partly inside the container and serving to retain the lid in the closed position. The frame is anchored to a front face and to two side faces of the selfsame container.

The outer wrapper generally bears a revenue stamp, which can be affixed in numerous different positions to suit the most disparate of requirements, whilst in some cases it is the practice to manufacture packets of the type thus described with inserts or coupons consisting in cards, leaflets or the like, bearing written information or figures or more generally pictures carrying a variety of messages directed at the consumer.

In accordance with the foregoing, the inner wrapper and the outer wrapper, be it fashioned from a sheet of wrapping material or from a precreased flat diecut blank, constitute specific and essential packaging components of the relative type of packet, whilst the revenue stamp and the coupon constitute additional packaging components.

Where groups of packets are wrapped as multiples, both the outer wrappers of rigid type and overwraps of the soft type constitute specific and essential packaging components.

Finally, single packets of cigarettes and multiple packs can be enveloped and sealed within a protective overwrap of transparent plastic material, typically polypropylene, also constituting a specific packaging component. It is the practice to print characters or bar codes on the outer wrapper of the packets and of cartons or soft carton-size packs such as will allow the immediate identification of information, using optical readers and without the need to open the pack, relating for example to the type of product, where it was manufactured, the date of manufacture and other such items of intelligence that will be of use to wholesalers and retailers for the purposes of organizing and managing their inventories.

In order to store additional data and information on packets, invisible from the outside and serving generally to discourage fraud, it is the practice to use ribbons of material with magnetic properties as a medium on which to memorize information, that is to say a magnetic stripe that can be recorded and read at any time thereafter using a scanner.

Conventionally, different types of ribbon are used widely in the tobacco industry for storing additional data and information on packets of cigarettes in manufacture; in particular, the ribbon utilized can be magnetizable or previously encoded.

Ribbons of the magnetizable type can be re-recorded with anti-counterfeiting codes and with manufacturing information. Pre-encoded ribbons on the other hand are supplied preferably in the already magnetized state and are used particularly as a source material for anti-counterfeiting stripes, as the information codes recorded on these stripes are unique.

The magnetic stripes described above constitute means having magnetic properties, on which to store data, and can be applied to packets of cigarettes at different points on the wrapper in such a way as to remain visible or invisible from the outside.

EP 967 161 discloses the application of a ribbon of magnetic material to a predetermined area of at least one specific packaging component of a packet.

In particular, EP 967 161 illustrates a typical portion of a packaging machine in which one of the specific packaging components, obtainable from a wrapping material procured as a continuous strip wound onto a roll constituting a temporary storage unit for the packaging component in question, is fed to a fixing station located on the machine; a ribbon with magnetic properties is also supplied to this same fixing station simultaneously, and applied to a predetermined area of the wrapping material in such a manner as to prepare a material ready for use in the manufacture of packets bearing a magnetic stripe.

Once beyond the fixing station, the wrapping material is directed toward a cutting station and divided into single sheets, each bearing a respective magnetic stripe, which will then pass through the successive stations utilized in manufacture of the single packets.

EP 967 161 also illustrates a typical portion of a machine as used in the manufacture of rigid packets, in which one of the specific packaging components, obtainable from a wrapping material procured in the form of diecut blanks, is fed to a fixing station located on the machine; discrete lengths of ribbon with magnetic properties are also supplied to this same fixing station simultaneously, and applied to a predetermined area of each blank in such a way as to prepare a material ready for use in the manufacture of packets bearing a magnetic stripe. Once beyond the fixing station, the wrapping material passes through the successive stations utilized in manufacture of the single packets.

In order to apply a ribbon with magnetic properties to the stock wrapping material, be it a continuous strip of material or a material consisting in blanks, an additional manufacturing step has to be carried out on the machine.

It follows therefore that packets bearing magnetic media of the type in question must of necessity be assembled on packers equipped with additional units for preparation of the wrapping material. Naturally the same also applies in the event that the magnetic stripes are applied to the aforementioned additional packaging components, namely the revenue stamp and the card or coupon.

To incorporate such units into traditional packers, substantial modifications need to be made since the units themselves are somewhat bulky and therefore their installation involves significant upheaval both in construction of the actual machines and in the course of integrating the modified machines into the manufacturing environment of the tobacco industry.

The object of the present invention is to provide a method for the preparation of wrapping material used in the manufacture of packets for tobacco products, and of cartons for such packets, such as will remain unaffected by the drawbacks described above.

### DISCLOSURE OF THE INVENTION

The stated object is realized according to the present invention in a method for the preparation of wrapping material used in the manufacture of packs for tobacco products, each pack comprising at least one specific packaging component, characterized in that it comprises the steps of advancing a wrapping material along a predetermined feed path to a first operating station; applying a medium to respective predetermined areas of the wrapping material, at the first operating station, having magnetic properties and capable of retaining data; advancing the wrapping material, furnished with the medium having magnetic properties, to a second operating station; ordering the wrapping material at the second operating station into respective temporary storage units such as can be utilized on respective machines for manufacturing the packs of tobacco products; and in that each pack consists in the specific packaging component obtained from the temporary storage unit and furnished with at least one medium having magnetic properties, capable of retaining data.

The invention will now be described in detail, by way of example, with the aid of the accompanying drawings, in which:

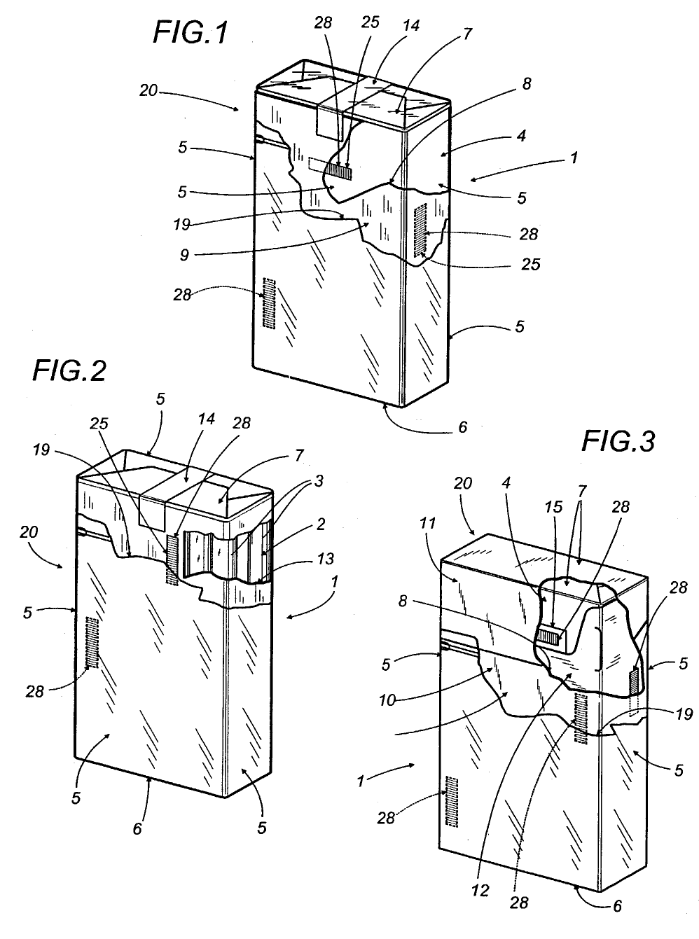

FIG. 1 shows a packet of soft type for tobacco products, viewed schematically and in perspective, comprising an inner wrapper and an outer wrapper cut away in part for clarity;

FIG. 2 shows a packet for tobacco products of the soft type consisting in a single sheet of material, viewed schematically and in perspective;

FIG. 3 shows a packet for tobacco products of the rigid type with a hinged lid, viewed schematically and in perspective with part of the outer wrapper cut away for clarity;

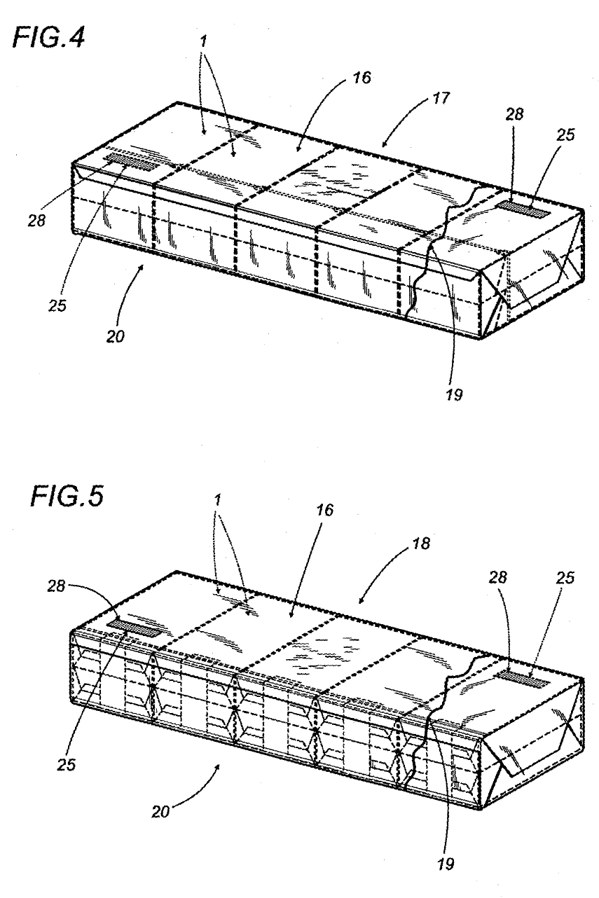

FIG. 4 shows a carton pack of the rigid type, viewed schematically and in perspective;

FIG. 5 shows a carton pack of the soft type, viewed schematically and in perspective;

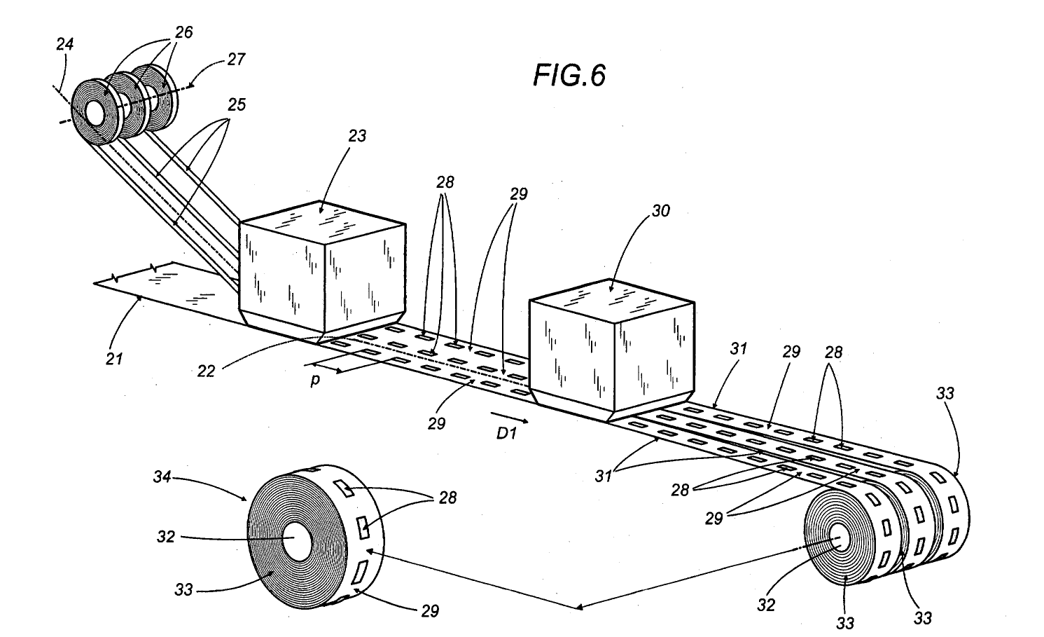

FIG. 6 shows a portion of a packaging line for the preparation of wrapping material utilized in the manufacture of packs for tobacco products, viewed schematically and in perspective and illustrated in a first embodiment;

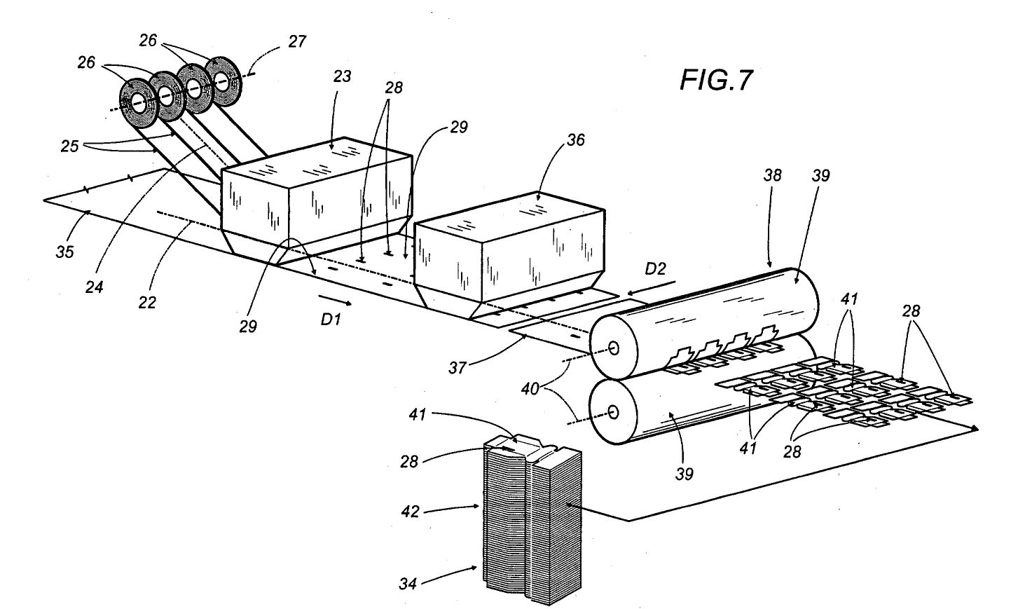

FIG. 7 shows a portion of a packaging line for the preparation of wrapping material utilized in the manufacture of packs for tobacco products, viewed schematically and in perspective and illustrated in a second embodiment;

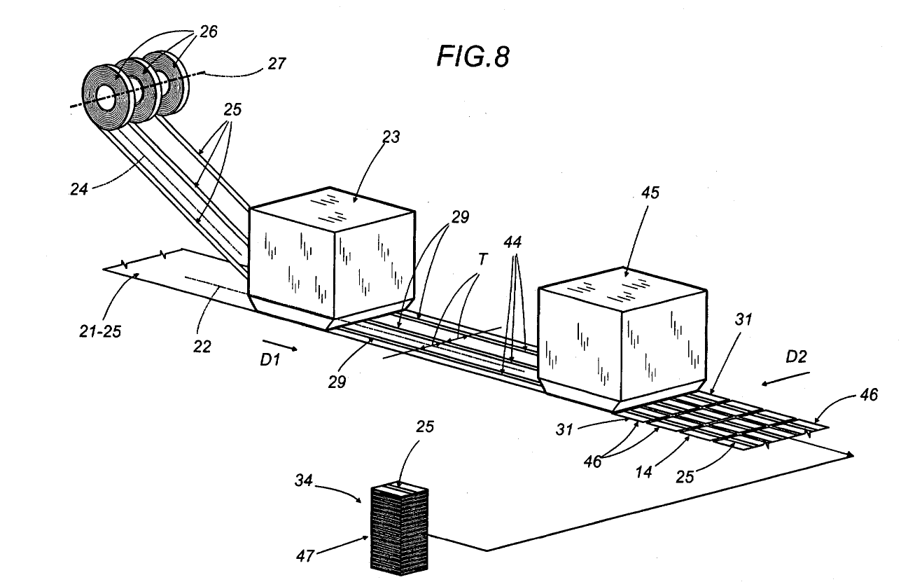

FIG. 8 shows an alternative embodiment of the portion of a line for the preparation of wrapping material as in FIGS. 6 and 7, viewed schematically and in perspective.

Referring to FIGS. 1, 2 and 3 of the accompanying drawings, 1 denotes a packet, in its entirety, such as will accommodate a substantially parallelepiped group 2 of cigarettes 3 (indicated in FIG. 2 only) which in the case of FIG. 1 is enveloped completely by an inner wrapper 4 fashioned from metal foil paper and presenting four side faces 5, a bottom end face 6 and a top end face 7.

In the packets 1 of FIG. 1 and FIG. 3 the inner wrapper 4 is accommodated within an outer wrapper 8 which in the example of FIG. 1, illustrating a soft packet 1, consists in a label 9 enveloping the inner wrapper 4 all except for the top end face 7, whereas in the example of FIG. 3, illustrating a rigid type of packet 1, the wrapper 8 in question comprises a container 10 of cupped embodiment, surmounted by a lid 11 likewise of cupped embodiment, hinged to the container 10 and capable thus of rotation between a closed position illustrated in FIG. 3 and an open position (not illustrated).

The rigid packet 1 also comprises a stiffening frame 12 positioned partly inside the container 10, anchored to the inside of the front face 5 and of two flank faces 5 presented by the selfsame container 10.

In the example of FIG. 2 the packet 1 has only one wrapper 13 replacing both the inner wrapper 4 and the outer wrapper 8 of the other examples.

The inner wrapper 4 and the outer wrapper 8 of both the rigid and the soft type of packet 1, likewise the wrapper 13 of the single-ply soft packet, together with the frame 12 of the rigid packet, all constitute specific and essential packaging components of the respective types of packet 1.

The aforementioned packets 1, soft and rigid alike, generally present a revenue stamp 14 which in the case of the soft type of packet 1 illustrated in FIGS. 1 and 2 is affixed straddling the top end face 7, whereas in the case of the rigid packet 1 the stamp (not illustrated) is affixed typically on a line along which the container 10 and the lid 11 are joined.

As illustrated in FIG. 3, the rigid packet 1 can include an insert 15 consisting for example in a card, a coupon or the like, bearing text, pictures or more generally images conveying messages of whatever nature directed at the smoker. The stamp 11 and the insert 15 constitute additional packaging components of the packet 1.

Referring to FIGS. 4 and 5, the packets 1 can be arranged in multiples and enveloped in respective overwraps 16 which in the example of FIG. 4 consist in a rigid carton 17, and in the example of FIG. 5, a carton-size pack 18 of soft type. Likewise in these two instances the respective overwraps 16 constitute specific packaging components.

Also, the three types of packet 1 illustrated in FIGS. 1, 2 and 3, the rigid carton 17 illustrated in FIG. 4 and the soft type of carton-size pack 18 illustrated in FIG. 5 can all be enveloped and sealed in a protective overwrap 19 of clear plastic material, such as polypropylene, which similarly constitutes a specific packaging component.

It will be observed that both the packets 1 and the rigid and soft cartons 17 and 18 constitute packs 20 for tobacco products, such as cigarettes 3.

Referring now to FIG. 6, a strip 21 of wrapping material is caused to advance along a predetermined feed path 22 toward a first operating station 23 to which ribbons 25 with magnetic properties capable of storing data, three in the example of FIG. 6, are also directed along a second predetermined path 24, decoiling from respective rolls 26 rotatable about a common axis 27 that extends transversely to the feed paths 22 and 24.

At the first operating station 23, each ribbon 25 is divided into discrete slivers 28 which are applied to respective predetermined areas 29 of the wrapping material 21, spaced apart at a selected pitch “p”. The ribbon 25 can be applied to the strip 21 in a variety of ways, according to whether the ribbon 25 is self-adhesive or affixed utilizing gumming means of conventional type, not illustrated, which will form part of the first operating station 23.

Emerging from the first station 23 furnished thus with respective slivers 28 of magnetic ribbon 25, the strip 21 of wrapping material is advanced toward a second operating station 30 where it is divided along a direction D1 parallel to the first feed path 22, through the agency of conventional cutting means (not illustrated) forming part of the second operating station 30, into a plurality of strips 31 equal in number to the number of magnetic ribbons 25 decoiled from the relative rolls 26. Each strip 31 presents substantially the same transverse dimension as that of the others, and is furnished with a succession of slivers 28 of the magnetic ribbon 25 coinciding with the aforementioned predetermined areas 29.

At a given point following the second operating station 30, considered in relation to the first feed path 22, each strip 31 is recoiled onto a respective core 32 to provide a roll 33 that will function as a respective temporary storage unit denoted 34.

The rolls 33 of strip 31 thus obtained by way of the operations described above will be transferred to a machine on which the aforementioned packs 20 are manufactured and, according to the type of wrapping material constituting the strip 21, used to fashion the specific packaging components: for example, the inner wrapper 4 of the packets 1 as illustrated in FIGS. 1 and 3, the outer wrapper 8 or label 9 of the packet 1 in FIG. 1, the single-ply wrapper 13 of the packet 1 in FIG. 2, and the frame 12 of the packet 1 in FIG. 3.

In addition, the rolls 33 can be used to prepare the overwrap 16 for the carton-size soft pack 18 shown in FIG. 5, and indeed for the preparation of a clear protective overwrap 19 of whatever nature applicable to any one of the packs 20 illustrated in FIGS. 1 to 5.

Similarly, when fitted to the relative machines used in manufacturing the various types of pack 20, the rolls 33 can be used for the application of revenue stamps 14 or coupons 15 constituting the aforementioned additional packaging components.

In the example of FIG. 7, and in like manner to the example illustrated in FIG. 6, a strip 35 of wrapping material is advanced along the predetermined feed path 22 toward the first operating station 23, to which ribbons 25 with magnetic properties capable of storing data, four in the example of FIG. 7, are also directed along the second predetermined path 24, decoiling from respective rolls 26 rotatable about a common axis 27 that extends transversely to the feed paths 22 and 24.

Following the step of applying the slivers 28 of magnetic ribbon 25 to the strip 35 in the manner already described with reference to the example of FIG. 6, the strip 35 is caused to advance, with the slivers 28 of magnetic ribbon 25 suitably positioned, toward a second operating station 36 where it is divided cyclically by cuts made along a direction D2 substantially transverse to the first feed path 22 in such a way as to generate a succession of sheets 37 which are directed into a third operating station 38 comprising a pair of die rollers 39 rotatable about axes 40 positioned one on either side of the first feed path 22 followed by the strip 35 and serving to cut a plurality of blanks 41 from each sheet 37, each blank 41 bearing a relative sliver 28 of magnetic ribbon 25.

The blanks 41 are then ordered into stacks 42 that will serve, as in the case of the rolls 33 mentioned above, to provide a temporary storage unit 34.

The stacks 42 of diecut blanks 41 thus obtained are supplied to the infeed of a machine on which the aforementioned packs 20 for tobacco products are manufactured.

In a different method of preparing the blanks 41, rather than passing through the third operating station 38, the cut sheets 37 could be transferred to an operating station not illustrated in the drawings and ordered one on top of another in groups (not illustrated), then punched conventionally in a single operation to generate a given number of stacks 42 simultaneously.

The stacks 42 of single blanks 41 generated from the strip 35 will be transferred to a machine on which the aforementioned packs 20 are manufactured and, according to the type of wrapping material constituting the strip 35, utilized to fashion the specific packaging components: for example, the outer wrapper 8 of the packet 1 illustrated in FIG. 3 or the overwrap 16 of the rigid carton 17 illustrated in FIG. 4.

In the example of FIG. 8, the method consists in applying a plurality of magnetic ribbons 25 to the wrapping material 21 or 35 at the first operating station 23, extending in continuous fashion along the aforementioned predetermined areas 29 and spaced apart transversely to the feed path 22 at identical distances T.

In this particular case the magnetic ribbons 25 are applied as continuous stripes 44.

Still in FIG. 8, the second operating station, denoted 45, is able not only to effect longitudinal cuts in the direction D1 followed by the strip 21 of material furnished with the continuous stripes 44 of magnetic ribbon 25, so as to generate the plurality of strips 31 as described above, but also a cyclical transverse cut in the transverse direction D2 serving to divide each strip 31 into a succession of discrete sheets 46 which, given a suitable type of material, could serve for example as revenue stamps 14; in like manner to the examples described above, the sheets 46 are ordered in stacks 47 serving as temporary storage units 34 that will be supplied to the infeed of a machine on which the aforementioned packs 20 for tobacco products are manufactured.

Likewise in the examples of FIGS. 6 and 7, the magnetic ribbons 25 could be applied as continuous stripes 44.

Naturally, in the example of FIG. 6 where the temporary storage units 34 consist in rolls 33, the second operating station 30 will be equipped with cutting means of conventional type (not illustrated) acting in the transverse direction D2, which come into operation each time a coiling roll 33 reaches the selected diameter.

The positioning of the magnetic ribbons 25 relative to the strips 21 and 35 of wrapping material can be effected in such a manner as to identify and select the placement of the discrete sliver 28 or continuous stripe 44 of magnetic ribbon 25 on the respective specific or additional packaging component in each instance. It will be appreciated that the discrete slivers 28 or continuous stripes 44 of ribbon 25 with magnetic properties might be applied to one of the specific and/or additional packaging components only, albeit in the various solutions of FIGS. 1 to 5 the packs are illustrated by way of example with at least two slivers 28 of magnetic ribbon 25.

1) A method for the preparation of wrapping material used in the manufacture of packs for tobacco products, each pack (20) comprising at least one specific packaging component (4, 8, 12, 13, 16, 19), characterized in that it comprises the steps of advancing a wrapping material (21; 35) in a first predetermined direction (D1) along a predetermined feed path (22) to a first operating station (23); applying a medium (25) to respective predetermined areas (29) of the wrapping material (21), at the first operating station (23), having magnetic properties and capable of retaining data; advancing the wrapping material (21), furnished with the medium (25) having magnetic properties, to a second operating station (30); ordering the wrapping material (21) at the second operating station (30) into respective temporary storage units (34) such as can be utilized on respective machines for manufacturing the packs (20) of tobacco products; and in that each pack (20) consists in the specific packaging component obtained from the temporary storage unit (34) and furnished with at least one medium (25) having magnetic properties capable of retaining data.

2) A method as in claim 1, comprising the steps, relative to the ordering step, of cutting the wrapping material (21) in a first direction (D1) parallel to the predetermined feed path (22), in such a way as to generate at least two strips (31) each presenting the predetermined areas (29) to which the medium (25) having magnetic properties is applied, and thereafter recoiling each strip (31) into a relative roll (33) constituting a temporary storage unit (34).

3) A method as in claim 1, comprising the steps, relative to the ordering step, of effecting a cut in a first direction (D1) parallel to the predetermined feed path (22) in such a way as to divide the wrapping material into at least two strips (31), effecting a further cut in a second direction (D2) transverse to the first direction (D1) to generate a plurality of sheets (46) of the wrapping material (21; 35), each presenting the predetermined areas (29) to which the medium (25) having magnetic properties is applied, and thereafter gathering the sheets (46) into relative stacks (47) each constituting a temporary storage unit (34).

4) A method as in claim 1, comprising the steps, relative to the ordering step, of effecting a cut in a second direction (D2) transverse to the first direction (D1) followed by the wrapping material (21; 35) advancing along the predetermined feed path (22), by which the material is divided into a plurality of sheets (37), then diecutting the sheets (37) to generate a plurality of blanks (41) each presenting the predetermined areas (29) to which the medium (25) having magnetic properties is applied, and thereafter gathering the blanks (41) into respective stacks (42) each constituting a temporary storage unit (34).

5) A method as in claim 1, comprising the steps, relative to the ordering step, of effecting a cut in a second direction (D2) transverse to the first direction (D1) followed by the wrapping material (21; 35) advancing along the predetermined feed path (22) to generate a plurality of sheets (37) of the selfsame material, and then diecutting the sheets (37) positioned one on top of another in groups so as to generate a plurality of stacks (42) of blanks (41) each presenting the predetermined areas (29) to which the medium (25) having magnetic properties is applied.

6) A method as in claim 1, wherein the medium (25) having magnetic properties consists in continuous stripes (44) of magnetic ribbon (25) capable of retaining data, applied to predetermined areas (29) extending continuously along the wrapping material (21; 35).

7) A method as in claim 1, wherein the medium (25) having magnetic properties consists in a plurality of discrete slivers (28) of magnetic ribbon capable of retaining data, applied to predetermined areas (29) located discontinuously and spaced apart at a predetermined pitch (p) along the wrapping material (21; 35).

8) A method as in claims 1 to 7, wherein each pack (20) comprises at least two specific packaging components of which at least one is obtained from a corresponding temporary storage unit (34) and furnished with at least one medium (25) having magnetic properties capable of retaining data.

9) A method as in claim 8, wherein the pack (20) comprises two specific packaging components of which one consists in an inner wrapper (4) and another consists in a rigid outer wrapper (8) with a hinged lid, also a third specific packaging component consisting in a stiffening frame (12) obtained from a corresponding temporary storage unit (34) and furnished with at least one medium (25) having magnetic properties capable of retaining data.

10) A method as in claim 8 or claim 9, wherein each pack (20) comprises at least two specific packaging components, and at least one additional packaging component (14, 15) obtained from a corresponding temporary storage unit (34) and furnished with at least one medium (25) having magnetic properties capable of retaining data.

11) A method as in claim 10, wherein the additional packaging component (14) is a revenue stamp.

12) A method as in claim 10, wherein the additional packaging component (15) is an insert or coupon.
